(19) United States
(12) Patent Application Publication
(10) Pub. No.: US 2010/0001907 A1
(43) Pub. Date: Jan. 7, 2010

(54) Compact planar antenna assembly

(75) Inventor: Tze Chung Wan, Tauyuan Hsien (TW)

Correspondence Address: CHARLES E. BAXLEY, ESQUIRE, 90 JOHN STREET, SUITE 309, NEW YORK, NY, 10038, US

(73) Assignee: Joymax Electronics Co., Ltd.

(21) Appl. No.: 12/217,079

(22) Filed: Jul. 1, 2008

(51) Int. Cl. H01Q 9/04

(52) U.S. Cl. 343/700 MS

(57) ABSTRACT

An antenna assembly includes a substrate having a feed line, and an antenna device having two inner radiators electrically coupled to the feed line and disposed at a distance from each other, and two outer radiators electrically coupled to the middle portions of the inner radiators for decreasing the dimension of the antenna assembly and for increasing the gain of the antenna assembly, the inner radiators each include an antenna segment disposed at a distance parallel to the inner radiators and disposed on an outer portion of the inner radiators, the inner radiators are electrically coupled to the outer radiators with a coupling element which includes either a zigzag shape or a wave-shaped structure.

### BACKGROUND OF THE INVENTION

1. Field of the Invention

The present invention relates to an antenna assembly, and more particularly to an antenna assembly including two opposite antenna devices for suitably decreasing the volume or the size or the dimension of the antenna assembly and for increasing the gain of the antenna assembly.

2. Description of the Prior Art

Typical antenna devices comprise one or more printed planar radiating elements applied or disposed on an earth plate or a printed circuit board or a substrate by painting or printing processes, and a ground plane positioned on one or both sides of the substrate, for transmitting or receiving waves or signals and for allowing the radiators to transmit or to receive waves or signals or different resonant frequencies.

For example, U.S. Pat. No. 6,664,926 to Zinanti et al. discloses one of the typical compact antenna devices comprising a radiating element in the shape of a right triangle and formed on a substrate, and a ground plane positioned on one or both sides of the substrate, and the typical antenna devices may include one or more triangular radiating elements arranged in groups of two or more in close proximity to one another, or arranged in an array.

However, for increasing the gain of the antenna devices, the sizes or the areas or the lengths or the dimensions of the substrate and/or the radiating elements of the typical antenna devices should be increased.

The applicant of the present invention has developed another typical antenna assembly and issued as U.S. Pat. No. 7,129,898 to Chou and comprising a circuit board, one antenna device disposed on one side of the circuit board for receiving and transmitting signals laterally, and another antenna device disposed on the other side of the circuit board for receiving and transmitting signals vertically.

However, the two antenna devices should be disposed on or applied to the two opposite sides of the circuit board such that the manufacturing processes for the typical antenna assembly will be complicated and such that the manufacturing cost of the typical antenna assembly will be increased.

The present invention has arisen to mitigate and/or obviate the afore-described disadvantages of the conventional antenna members or devices.

### SUMMARY OF THE INVENTION

The primary objective of the present invention is to provide an antenna assembly including two opposite antenna devices for suitably decreasing the volume or the size or the dimension of the antenna assembly and for increasing the gain of the antenna assembly.

In accordance with one aspect of the invention, there is provided an antenna assembly comprising a substrate including a feed line, and an antenna device including two first radiators disposed on the substrate and electrically coupled to the feed line, and the first radiators being disposed at a distance from each other and each including a middle portion, and two second radiators disposed on the substrate and electrically coupled to the middle portions of the first radiators respectively for suitably decreasing the volume or the size or the dimension of the antenna assembly and for increasing the gain of the antenna assembly.

The first radiators each include an antenna segment disposed at a distance parallel to the first radiators. The antenna segments are preferably disposed on an outer portion of the first radiators respectively.

The middle portions of the first radiators are each electrically coupled to the second radiators with a coupling element. The coupling elements each may include either a zigzag shape or a wave-shaped structure for further decreasing the volume or the size or the dimension of the antenna assembly.

A second antenna device may further be provided and include two third radiators disposed on the substrate and electrically coupled to the feed line for further increasing the gain of the antenna assembly. It is preferable that the second antenna device include a structure opposite to that of the first antenna device in a mirror image.

The third radiators are disposed at a distance from each other and each include a middle portion, and two fourth radiators disposed on the substrate and electrically coupled to the middle portions of the third radiators respectively.

The third radiators each include an antenna segment disposed at a distance parallel to the third radiators. The antenna segments of the third radiators are disposed on an outer portion of the third radiators respectively.

The middle portions of the third radiators are each electrically coupled to the fourth radiators with a conductive coupling element. The coupling elements of the second antenna device each include either a zigzag shape or a wave-shaped structure for further decreasing the volume or the size or the dimension of the antenna assembly.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a top plan schematic view of an antenna assembly in accordance with the present invention;

FIG. 2 is a plan schematic view illustrating the testing results of the gain versus frequencies;

FIG. 3 is a plan schematic view illustrating the erected or vertical plane (E-Plane) of the radiation of the antenna assembly when conducted with a frequency of 2.45 GHz;

FIG. 4 is another plan schematic view illustrating the horizontal plane (H-Plane) of the radiation of the antenna assembly when conducted with the frequency of 2.45 GHz;

FIG. 5 is a plan schematic view illustrating the erected or vertical plane (E-Plane) of the radiation of the antenna assembly when conducted with a frequency of 5.25 GHz;

FIG. 6 is another plan schematic view illustrating the horizontal plane (H-Plane) of the radiation of the antenna assembly when conducted with the frequency of 5.25 GHz;

FIG. 7 is a plan schematic view illustrating the erected or vertical plane (E-Plane) of the radiation of the antenna assembly when conducted with a frequency of 5.75 GHz;

FIG. 8 is another plan schematic view illustrating the horizontal plane (H-Plane) of the radiation of the antenna assembly when conducted with the frequency of 5.75 GHz;

FIG. 9 is a top plan schematic view similar to FIG. 1, illustrating the other arrangement of the antenna assembly; and

FIG. 10 is a plan schematic view illustrating the testing results of the gain versus frequencies of the antenna assembly as shown in FIG. 9.

### DETAILED DESCRIPTION OF THE PREFERRED EMBODIMENT

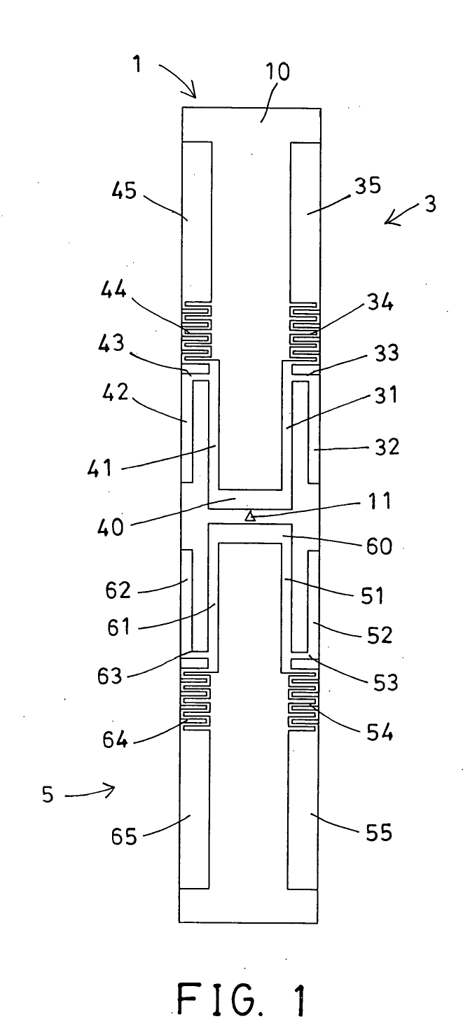

Referring to the drawings, and initially to FIG. 1, an antenna assembly 1 in accordance with the present invention comprises a printed circuit board or earth plate or substrate 10 including a feed line 11 provided or attached to the middle portion of the substrate 10 for transmitting or receiving waves or signals, and two antenna devices 3, 5 attached to or disposed on the same side or the upper portion of the substrate 10, but disposed on the two opposite ends of the substrate 10, and also disposed on the two opposite ends of the feed line 11 and electrically coupled to the feed line 11. It is preferable that the antenna devices 3, 5 include a structure opposite to each other in a mirror image.

For example, one of the antenna devices 3 includes two antenna members or radiators 31, 41 attached to or disposed on the substrate 10, and arranged side by side with each other, and coupled together with a coupling member 40 which is then electrically coupled to the feed line 11, and the radiators 31, 41 each include a free end or antenna segment 32, 42 bent or disposed at a distance essentially parallel to the radiators 31, 41 and disposed on the outside or outer portion of the radiators 31, 41, and each include a middle portion 33, 43 electrically coupled to another radiator 35, 45 directly or indirectly with a coupling element 34, 44.

It is to be noted that the provision and/or the arrangement of the radiators 31, 35; and 41, 45 allows the antenna assembly 1 in accordance with the present invention to be operated in high frequencies, and the provision and/or the arrangement of the antenna segment 32, 42 on the outer portion or the side portion of the radiators 31, 41 allows the antenna assembly 1 in accordance with the present invention to be operated in low frequencies, such that the antenna assembly 1 may be operated in both high and low frequencies or in different resonant frequencies.

The coupling elements 34, 44 may include a zigzag shape or a wave-shaped structure for increasing the coupling distance between the radiators 31, 35; and 41, 45, and for facilitating the signal transmitting and/or receiving effects for the radiators 31, 35; and 41, 45. In addition, the provision and/or the arrangement of the two opposite antenna devices 3, 5 may further increase the gain for the antenna assembly 1. The antenna device 5 may include a structure arranged opposite to the other antenna device 3 in the mirror image, and may also include two radiators 51, 61 attached to or disposed on the substrate 10, and arranged side by side with each other, and coupled together with a coupling member 60 which is then electrically coupled to the feed line 11, and the radiators 51, 61 each include a free end or antenna segment 52, 62 bent or disposed at a distance essentially parallel to the radiators 51, 61 and disposed on the outside or outer portion of the radiators 51, 61, and each include a middle portion 53, 63 electrically coupled to another radiator 55, 65 directly or indirectly with a coupling element 54, 64.

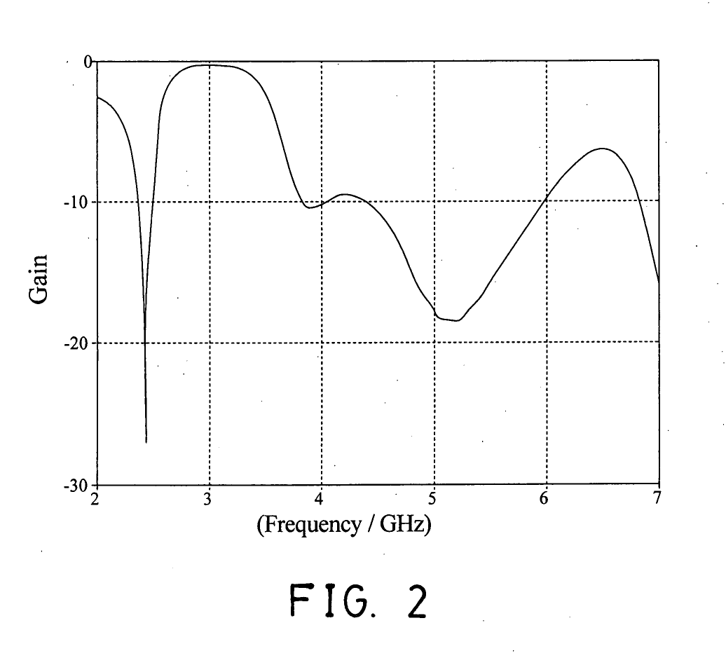

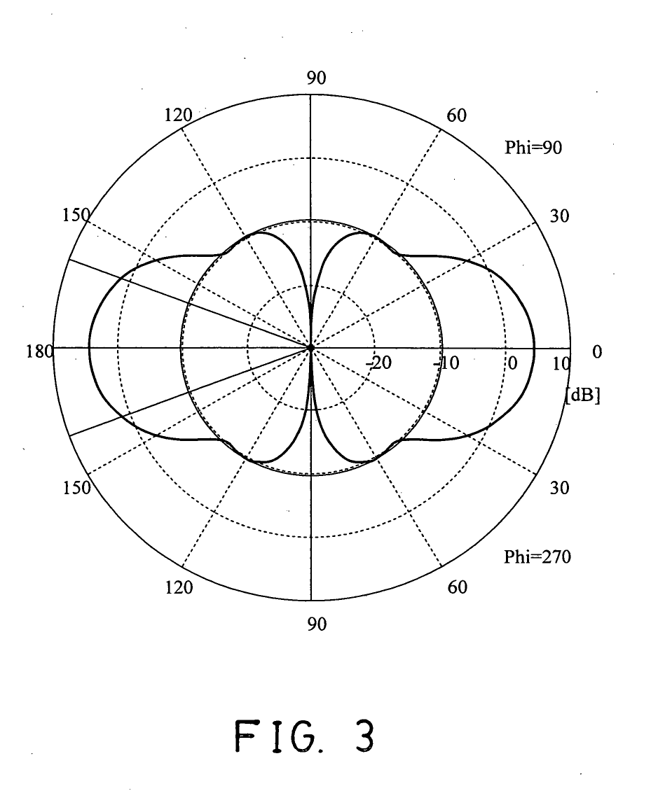

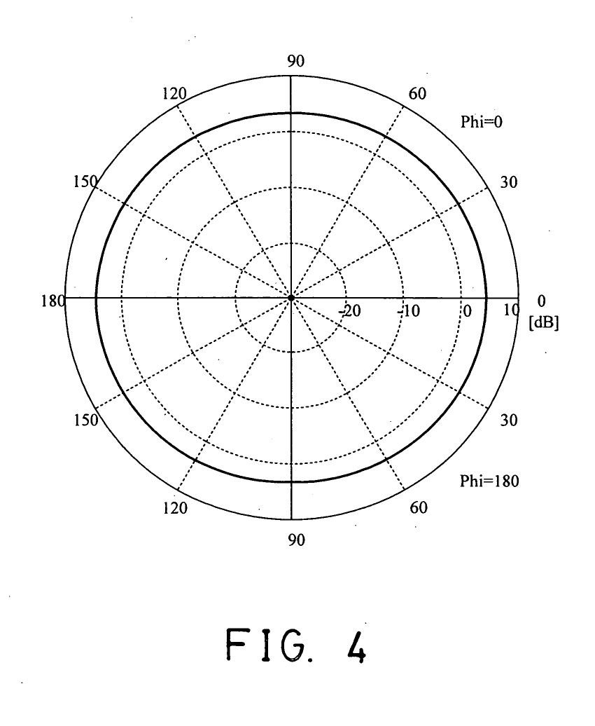

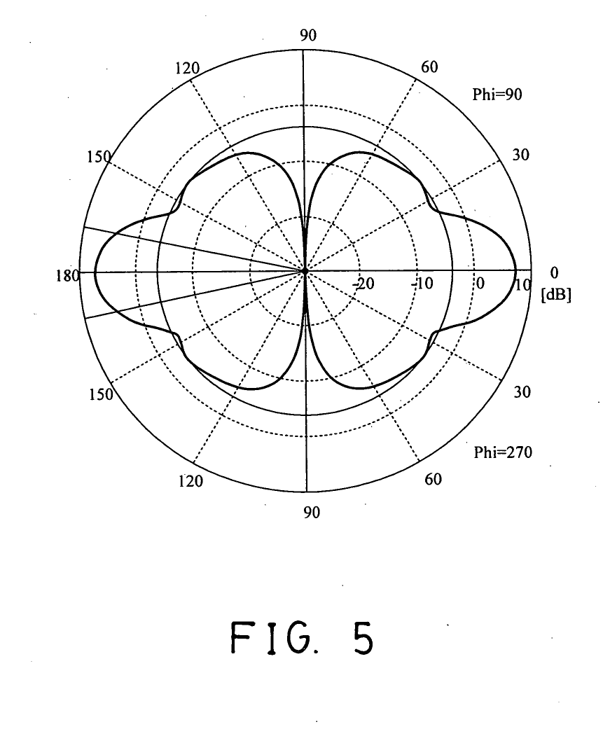

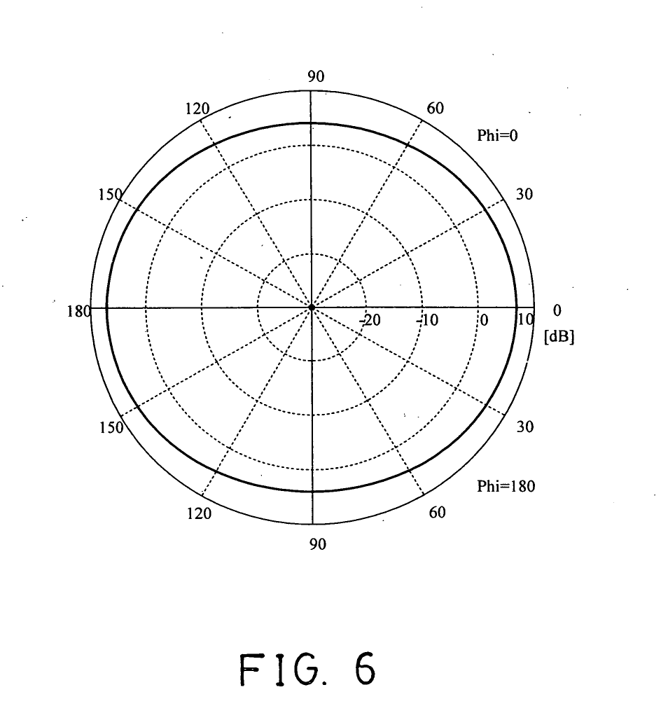

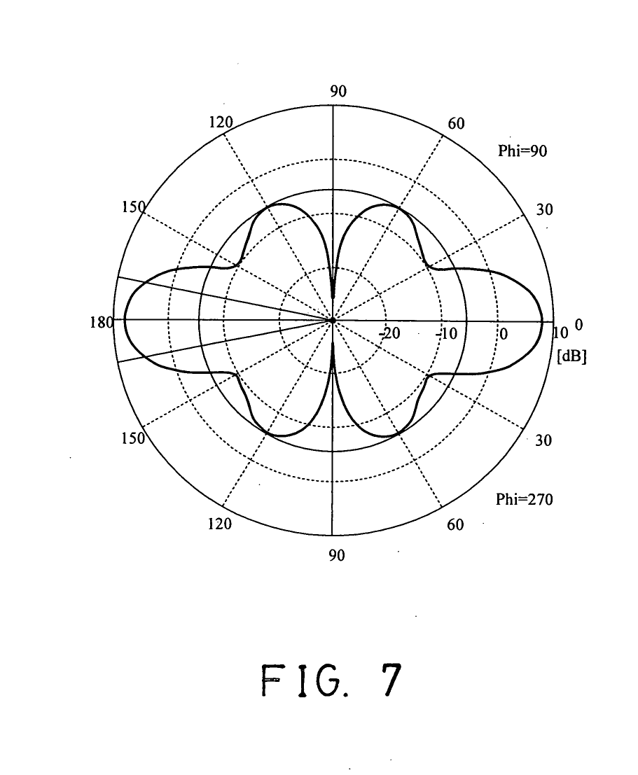

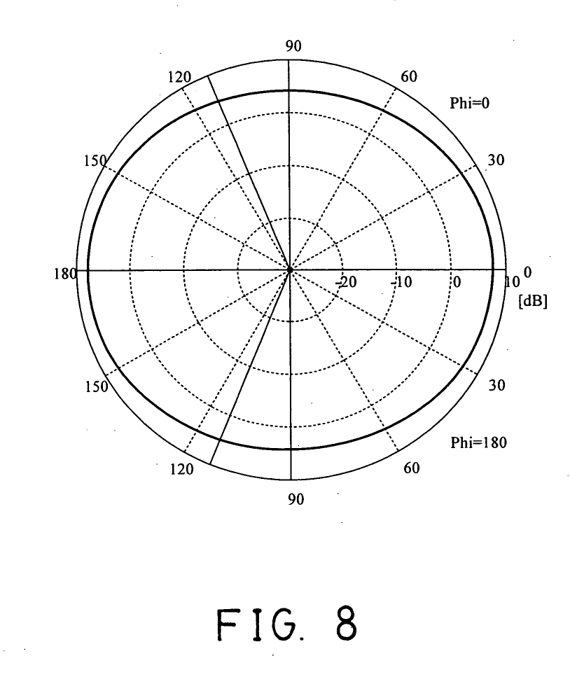

For example, as shown in FIG. 2, illustrated are the testing results of the gain versus frequencies for the antenna assembly 1, and as shown in FIGS. 3-8, illustrated are the erected or vertical plane (E-Plane) and the horizontal plane (H-Plane) of the radiation of the antenna assembly 1 respectively when conducted with the frequencies of 2.45 GHz, 5.25 GHz, and 5.75 GHz respectively, in which the gain for the antenna assembly 1 may be suitably increased. The lengths of the radiators 31, 41, and/or of the antenna segments 32, 42, and/or of the other radiators 35, 45 may be changed or increased or decreased to change the working frequencies for the antenna assembly 1.

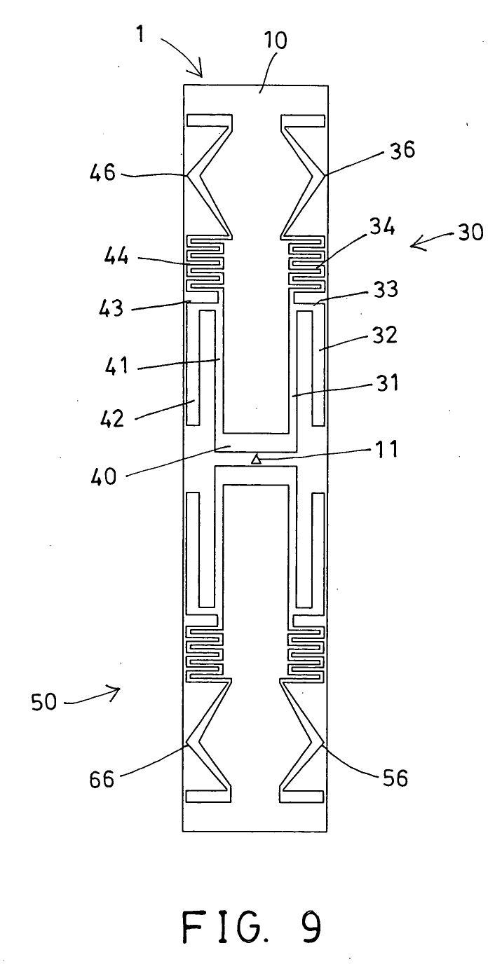

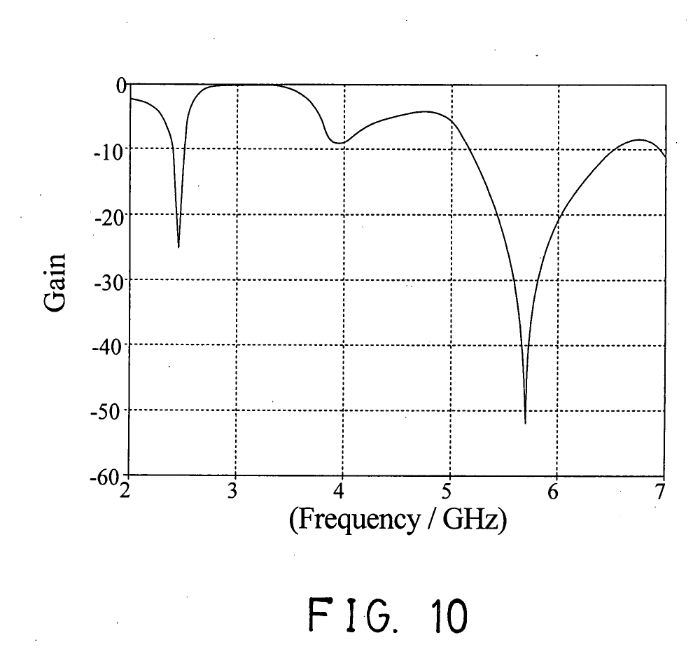

Alternatively, the radiators 31, 41; and 35, 45 may be bent or may be changed to the other shapes or structures or configurations for increasing the length of the radiators 31, 41; and 35, 45 and for further increasing the gain of the antenna assembly 1, and for further decreasing the volume or the size or the dimension of the antenna assembly 1. For example, as shown in FIGS. 9 and 10, the radiators 36, 46; and 56, 66 of the antenna devices 30, 50 may be changed to the other shapes or structures or configurations, such as the “C” shaped structure for decreasing the size or the dimension of the antenna assembly 1 and for further increasing the gain of the antenna assembly 1.

Accordingly, the antenna assembly in accordance with the present invention includes two opposite antenna devices for suitably decreasing the volume or the size or the dimension of the antenna assembly and for increasing the gain of the antenna assembly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna assembly comprising:
a substrate including a feed line, and
an antenna device including two first radiators disposed on said substrate and electrically coupled to said feed line, and said first radiators being disposed at a distance from each other and each including a middle portion, and two second radiators disposed on said substrate and electrically coupled to said middle portions of said first radiators respectively.

2. The antenna assembly as claimed in claim 1, wherein said first radiators each include an antenna segment disposed at a distance parallel to said first radiators.

3. The antenna assembly as claimed in claim 2, wherein said antenna segments are disposed on an outer portion of said first radiators respectively.

4. The antenna assembly as claimed in claim 1, wherein said middle portions of said first radiators are each electrically coupled to said second radiators with a coupling element.

5. The antenna assembly as claimed in claim 4, wherein said coupling elements each include a zigzag shape.

6. The antenna assembly as claimed in claim 4, wherein said coupling elements each include a wave-shaped structure.

7. The antenna assembly as claimed in claim 1 further comprising a second antenna device including two third radiators disposed on said substrate and electrically coupled to said feed line.

8. The antenna assembly as claimed in claim 7, wherein said third radiators are disposed at a distance from each other and each include a middle portion, and two fourth radiators disposed on said substrate and electrically coupled to said middle portions of said third radiators respectively.

9. The antenna assembly as claimed in claim 8, wherein said third radiators each include an antenna segment disposed at a distance parallel to said third radiators.

10. The antenna assembly as claimed in claim 9, wherein said antenna segments of said third radiators are disposed on an outer portion of said third radiators respectively.

11. The antenna assembly as claimed in claim 8, wherein said middle portions of said third radiators are each electrically coupled to said fourth radiators with a coupling element.

12. The antenna assembly as claimed in claim 11, wherein said coupling elements of said second antenna device each include a zigzag shape.

13. The antenna assembly as claimed in claim 11, wherein said coupling elements of said second antenna device each include a wave-shaped structure.

14. An antenna assembly comprising:
a substrate including a feed line,
a first antenna device including two first radiators disposed on said substrate and electrically coupled to said feed line, and two second radiators disposed on said substrate and electrically coupled to said first radiators respectively, and
a second antenna device including two third radiators disposed on said substrate and electrically coupled to said feed line, and two fourth radiators disposed on said substrate and electrically coupled to said third radiators respectively.

15. The antenna assembly as claimed in claim 14, wherein said first radiators each include a middle portion electrically coupled to said second radiators, and said third radiators each include a middle portion electrically coupled to said fourth radiators.

16. The antenna assembly as claimed in claim 15, wherein said middle portions of said first radiators are each electrically coupled to said second radiators with a coupling element, and said middle portions of said third radiators are each electrically coupled to said fourth radiators with a coupling element.

17. The antenna assembly as claimed in claim 16, wherein said coupling elements of said first and said second antenna devices each include a zigzag shape.

18. The antenna assembly as claimed in claim 16, wherein said coupling elements of said first and said second antenna devices each include a wave-shaped structure.

19. The antenna assembly as claimed in claim 14, wherein said first radiators each include an antenna segment disposed at a distance parallel to said first radiators, and said third radiators each include an antenna segment disposed at a distance parallel to said third radiators.
